(19) United States
(12) Patent Application Publication
(10) Pub. No.: US 2025/0111432 A1
(43) Pub. Date: Apr. 3, 2025

(54) METHOD AND SYSTEM FOR PROVIDING SYNTHETIC NEURAL DATA MODELS

(71) Applicant: JPMorgan Chase Bank, N.A., New York, NY (US)

(72) Inventors: Leo ARDON, London (GB); Nelson VADORI, New York, NY (US); Mengda XU, Jersey City, NJ (US); Sumitra GANESH, Short Hills, NJ (US)

(73) Assignee: JPMorgan Chase Bank, N.A., New York, NY (US)

(21) Appl. No.: 18/375,098

(22) Filed: Sep. 29, 2023

(51) Int. Cl. G06Q 40/04; G06Q 30/0201

(52) U.S. Cl. CPC G06Q 40/04; G06Q 30/0201

(57) ABSTRACT

A method for providing a synthetic neural data model is disclosed. The method includes generating a model that simulates an electronic communication network; appending agents to the model, the agents relating to a software component that sends orders to the model based on a predetermined timestep; assigning a fixed grid to the model, the fixed grid including a tick size that relates to a fixed granularity; calibrating each of the agents by using a calibration data set; inputting the model and historical book data to a neural network; and training, via the neural network, a neural network extension of the model by using an optimizer.

### BACKGROUND

### 1. Field of the Disclosure

This technology generally relates to methods and systems for data modeling, and more particularly to methods and systems for providing a synthetic neural data model that facilitates realistic simulation environments by using a neural network architecture that leverages historical information.

### 2. Background Information

Many business entities utilize various data models to facilitate simulation of real world environments such as, for example, an electronic communication network. Often, these real world environments are dynamic systems that dramatically change according to numerous inputs and stimuli. Historically, implementations of conventional data modeling techniques have resulted in varying degrees of success with respect to producing realistic simulation environments.

One drawback of using the conventional data modeling techniques is that in many instances, a realistic simulation environment may require a data model to evolve based on actions taken by participants of the environment. As a result, all actions of the participants must be taken into consideration to accurately determine impact. Additionally, the model may be required to learn and exploit the inherent dependencies of system dynamics based on historical information.

Therefore, there is a need for a synthetic neural data model that facilitates realistic simulation environments by using a neural network architecture that leverages historical information.

### SUMMARY

The present disclosure, through one or more of its various aspects, embodiments, and/or specific features or sub-components, provides, inter alia, various systems, servers, devices, methods, media, programs, and platforms for providing a synthetic neural data model that facilitates realistic simulation environments by using a neural network architecture that leverages historical information.

According to an aspect of the present disclosure, a method for providing a synthetic neural data model is disclosed. The method is implemented by at least one processor. The method may include generating a model that simulates an electronic communication network; appending at least one agent to the model, the at least one agent may relate to a software component that sends at least one order to the model based on a predetermined timestep; assigning a fixed grid to the model, the fixed grid may include a tick size that relates to a fixed granularity; calibrating each of the at least one agent by using a calibration data set; inputting the model and historical book data to a neural network; and training, via the neural network, a neural network extension of the model by using an optimizer.

In accordance with an exemplary embodiment, the at least one model may include support for a plurality of orders that relate to at least one from among a market order, a limit order, and a cancel order, the support may enable the plurality of orders on a bid and ask side.

In accordance with an exemplary embodiment, each of the plurality of orders may be tracked by using the at least one model with a first-in-first-out mechanism, each of the plurality of orders may include a corresponding originator.

In accordance with an exemplary embodiment, the calibration data set may relate to level two limit order book data, the calibration data set may include at least one limit order book snapshot for each of a plurality of predetermined times.

In accordance with an exemplary embodiment, to train the neural network extension, the method may further include training the neural network extension by using the optimizer; and plotting a learning curve for the neural network extension.

In accordance with an exemplary embodiment, the method may further include initializing at least one neural network weight by using an initialization function to ensure uniform distribution, wherein the at least one neural network weight may relate to a parameter within the neural network extension that transforms input data within a hidden layer of the neural network extension.

In accordance with an exemplary embodiment, the method may further include assessing at least one performance parameter of the model and the neural network extension by using at least one from among a training data set, a validation data set, and a test data set, wherein the at least one performance parameter may include a validation loss parameter; and wherein the training of the neural network extension may be stopped when the validation loss parameter increases beyond a predetermined validation loss threshold.

In accordance with an exemplary embodiment, the method may further include predicting, via the model, at least one change in volume at each of a plurality of levels; and splitting an output into at least one component output for transmitting to the electronic communication network.

In accordance with an exemplary embodiment, the model may include at least one from among a machine learning model, a mathematical model, a process model, and a data model.

According to an aspect of the present disclosure, a computing device configured to implement an execution of a method for providing a synthetic neural data model is disclosed. The computing device including a processor; a memory; and a communication interface coupled to each of the processor and the memory, wherein the processor may be configured to generate a model that simulates an electronic communication network; append at least one agent to the model, the at least one agent may relate to a software component that sends at least one order to the model based on a predetermined timestep; assign a fixed grid to the model, the fixed grid may include a tick size that relates to a fixed granularity; calibrate each of the at least one agent by using a calibration data set; input the model and historical book data to a neural network; and train, via the neural network, a neural network extension of the model by using an optimizer.

In accordance with an exemplary embodiment, the at least one model may include support for a plurality of orders that relate to at least one from among a market order, a limit order, and a cancel order, the support may enable the plurality of orders on a bid and ask side.

In accordance with an exemplary embodiment, the processor may be further configured to track each of the plurality of orders by using the at least one model with a first-in-first-out mechanism, each of the plurality of orders may include a corresponding originator.

In accordance with an exemplary embodiment, the calibration data set may relate to level two limit order book data, the calibration data set may include at least one limit order book snapshot for each of a plurality of predetermined times.

In accordance with an exemplary embodiment, to train the neural network extension, the processor may be further configured to train the neural network extension by using the optimizer; and plot a learning curve for the neural network extension.

In accordance with an exemplary embodiment, the processor may be further configured to initialize at least one neural network weight by using an initialization function to ensure uniform distribution, wherein the at least one neural network weight may relate to a parameter within the neural network extension that transforms input data within a hidden layer of the neural network extension.

In accordance with an exemplary embodiment, the processor may be further configured to assess at least one performance parameter of the model and the neural network extension by using at least one from among a training data set, a validation data set, and a test data set, wherein the at least one performance parameter may include a validation loss parameter; and wherein the training of the neural network extension may be stopped when the validation loss parameter increases beyond a predetermined validation loss threshold.

In accordance with an exemplary embodiment, the processor may be further configured to predict, via the model, at least one change in volume at each of a plurality of levels; and split an output into at least one component output for transmitting to the electronic communication network.

In accordance with an exemplary embodiment, the model may include at least one from among a machine learning model, a mathematical model, a process model, and a data model.

According to an aspect of the present disclosure, a non-transitory computer readable storage medium storing instructions for providing a synthetic neural data model is disclosed. The storage medium including executable code which, when executed by a processor, may cause the processor to generate a model that simulates an electronic communication network; append at least one agent to the model, the at least one agent may relate to a software component that sends at least one order to the model based on a predetermined timestep; assign a fixed grid to the model, the fixed grid may include a tick size that relates to a fixed granularity; calibrate each of the at least one agent by using a calibration data set; input the model and historical book data to a neural network; and train, via the neural network, a neural network extension of the model by using an optimizer.

In accordance with an exemplary embodiment, the at least one model may include support for a plurality of orders that relate to at least one from among a market order, a limit order, and a cancel order, the support may enable the plurality of orders on a bid and ask side.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a synthetic neural data model that facilitates realistic simulation environments by using a neural network architecture that leverages historical information.

FIG. 4 is a flowchart of an exemplary process for implementing a method for providing a synthetic neural data model that facilitates realistic simulation environments by using a neural network architecture that leverages historical information.

FIG. 5 is a neural network architecture diagram of an exemplary training process for implementing a method for providing a synthetic neural data model that facilitates realistic simulation environments by using a neural network architecture that leverages historical information.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

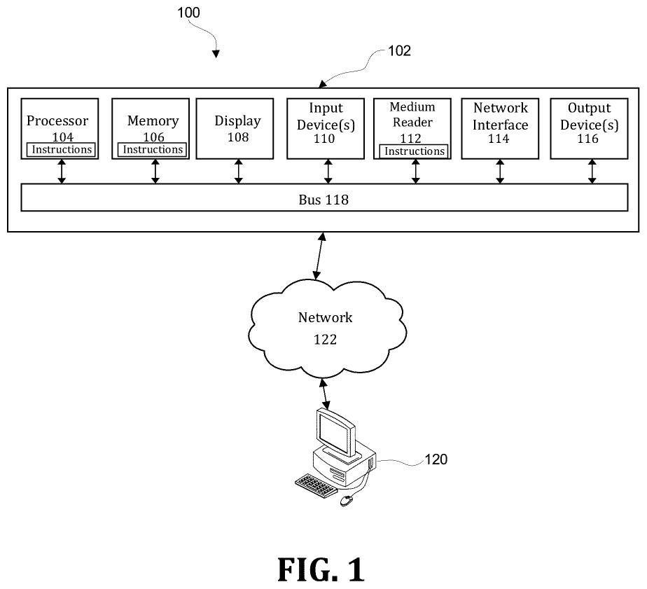

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing a synthetic neural data model that facilitates realistic simulation environments by using a neural network architecture that leverages historical information.

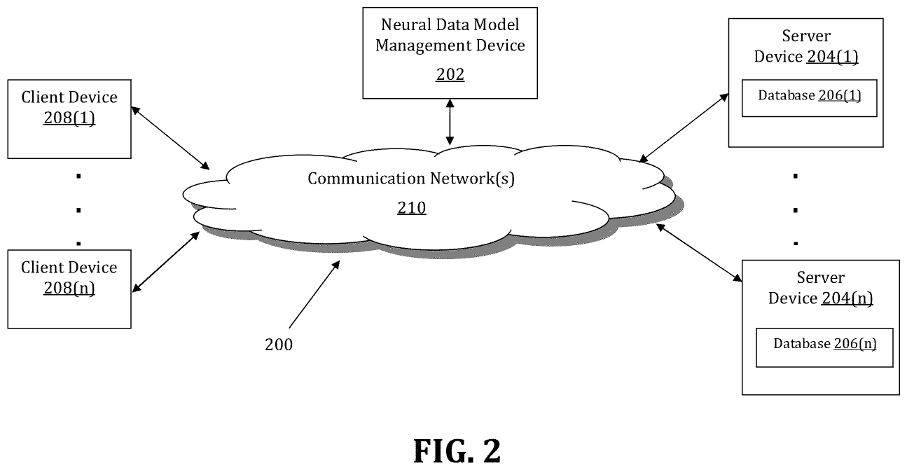

Referring to FIG. 2, a schematic of an exemplary network environment 200 for implementing a method for providing a synthetic neural data model that facilitates realistic simulation environments by using a neural network architecture that leverages historical information is illustrated. In an exemplary embodiment, the method is executable on any networked computer platform, such as, for example, a personal computer (PC).

The method for providing a synthetic neural data model that facilitates realistic simulation environments by using a neural network architecture that leverages historical information may be implemented by a Neural Data Model Management (NDMM) device 202. The NDMM device 202 may be the same or similar to the computer system 102 as described with respect to FIG. 1. The NDMM device 202 may store one or more applications that can include executable instructions that, when executed by the NDMM device 202, cause the NDMM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the NDMM device 202 itself, may be located in virtual server(s) running in a cloud-based computing environment rather than being tied to one or more specific physical network computing devices. Also, the application(s) may be running in one or more virtual machines (VMs) executing on the NDMM device 202. Additionally, in one or more embodiments of this technology, virtual machine(s) running on the NDMM device 202 may be managed or supervised by a hypervisor.

In the network environment 200 of FIG. 2, the NDMM device 202 is coupled to a plurality of server devices 204(1)-204 (n) that hosts a plurality of databases 206(1)-206 (n), and also to a plurality of client devices 208(1)-208 (n) via communication network(s) 210. A communication interface of the NDMM device 202, such as the network interface 114 of the computer system 102 of FIG. 1, operatively couples and communicates between the NDMM device 202, the server devices 204(1)-204 (n), and/or the client devices 208(1)-208 (n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the NDMM device 202, the server devices 204(1)-204 (n), and/or the client devices 208(1)-208 (n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and NDMM devices that efficiently implement a method for providing a synthetic neural data model that facilitates realistic simulation environments by using a neural network architecture that leverages historical information.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The NDMM device 202 may be a standalone device or integrated with one or more other devices or apparatuses, such as one or more of the server devices 204(1)-204 (n), for example. In one particular example, the NDMM device 202 may include or be hosted by one of the server devices 204(1)-204 (n), and other arrangements are also possible. Moreover, one or more of the devices of the NDMM device 202 may be in a same or a different communication network including one or more public, private, or cloud networks, for example.

The plurality of server devices 204(1)-204 (n) may be the same or similar to the computer system 102 or the computer device 120 as described with respect to FIG. 1, including any features or combination of features described with respect thereto. For example, any of the server devices 204(1)-204 (n) may include, among other features, one or more processors, a memory, and a communication interface, which are coupled together by a bus or other communication link, although other numbers and/or types of network devices may be used. The server devices 204(1)-204 (n) in this example may process requests received from the NDMM device 202 via the communication network(s) 210 according to the HTTP-based and/or JavaScript Object Notation (JSON) protocol, for example, although other protocols may also be used.

The server devices 204(1)-204 (n) may be hardware or software or may represent a system with multiple servers in a pool, which may include internal or external networks. The server devices 204(1)-204 (n) hosts the databases 206(1)-206 (n) that are configured to store data that relates to models, electronic communication networks, order books, agents, fixed grids, calibration data sets, training data sets, validation data sets, and test data sets.

Although the server devices 204(1)-204 (n) are illustrated as single devices, one or more actions of each of the server devices 204(1)-204 (n) may be distributed across one or more distinct network computing devices that together comprise one or more of the server devices 204(1)-204 (n). Moreover, the server devices 204(1)-204 (n) are not limited to a particular configuration. Thus, the server devices 204(1)-204 (n) may contain a plurality of network computing devices that operate using a controller/agent approach, whereby one of the network computing devices of the server devices 204(1)-204 (n) operates to manage and/or otherwise coordinate operations of the other network computing devices.

The server devices 204(1)-204 (n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208 (n) may also be the same or similar to the computer system 102 or the computer device 120 as described with respect to FIG. 1, including any features or combination of features described with respect thereto. For example, the client devices 208(1)-208 (n) in this example may include any type of computing device that can interact with the NDMM device 202 via communication network(s) 210. Accordingly, the client devices 208(1)-208 (n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208 (n) may run interface applications, such as standard web browsers or standalone client applications, which may provide an interface to communicate with the NDMM device 202 via the communication network(s) 210 in order to communicate user requests and information. The client devices 208(1)-208 (n) may further include, among other features, a display device, such as a display screen or touchscreen, and/or an input device, such as a keyboard, for example.

Although the exemplary network environment 200 with the NDMM device 202, the server devices 204(1)-204 (n), the client devices 208(1)-208 (n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the NDMM device 202, the server devices 204(1)-204 (n), or the client devices 208(1)-208 (n), for example, may be configured to operate as virtual instances on the same physical machine. In other words, one or more of the NDMM device 202, the server devices 204(1)-204 (n), or the client devices 208(1)-208 (n) may operate on the same physical device rather than as separate devices communicating through communication network(s) 210. Additionally, there may be more or fewer NDMM devices 202, server devices 204(1)-204 (n), or client devices 208(1)-208 (n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

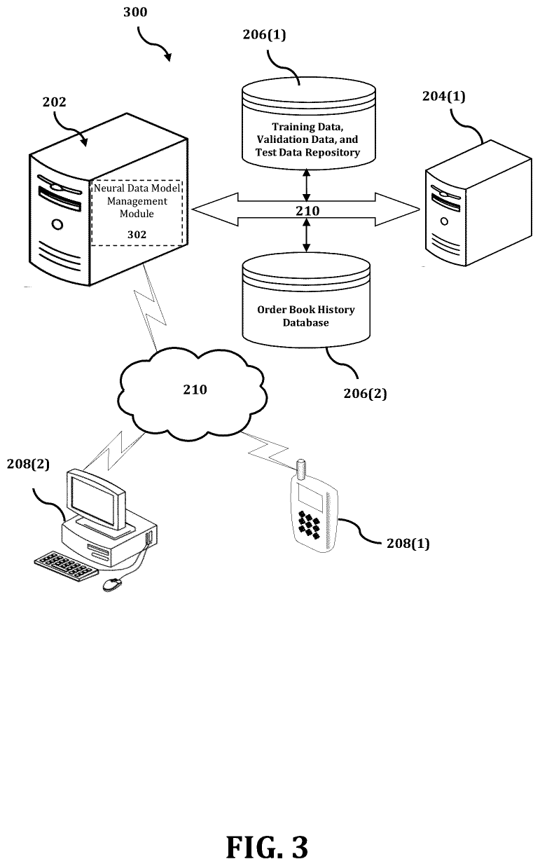

The NDMM device 202 is described and shown in FIG. 3 as including a neural data model management module 302, although it may include other rules, policies, modules, databases, or applications, for example. As will be described below, the neural data model management module 302 is configured to implement a method for providing a synthetic neural data model that facilitates realistic simulation environments by using a neural network architecture that leverages historical information.

An exemplary process 300 for implementing a mechanism for providing a synthetic neural data model that facilitates realistic simulation environments by using a neural network architecture that leverages historical information by utilizing the network environment of FIG. 2 is shown as being executed in FIG. 3. Specifically, a first client device 208(1) and a second client device 208(2) are illustrated as being in communication with NDMM device 202. In this regard, the first client device 208(1) and the second client device 208(2) may be “clients” of the NDMM device 202 and are described herein as such. Nevertheless, it is to be known and understood that the first client device 208(1) and/or the second client device 208(2) need not necessarily be “clients” of the NDMM device 202, or any entity described in association therewith herein. Any additional or alternative relationship may exist between either or both of the first client device 208(1) and the second client device 208(2) and the NDMM device 202, or no relationship may exist.

Further, NDMM device 202 is illustrated as being able to access a training data, validation data, and test data repository 206(1) and an order book history database 206(2). The neural data model management module 302 may be configured to access these databases for implementing a method for providing a synthetic neural data model that facilitates realistic simulation environments by using a neural network architecture that leverages historical information.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the NDMM device 202 via broadband or cellular communication. Of course, these embodiments are merely exemplary and are not limiting or exhaustive.

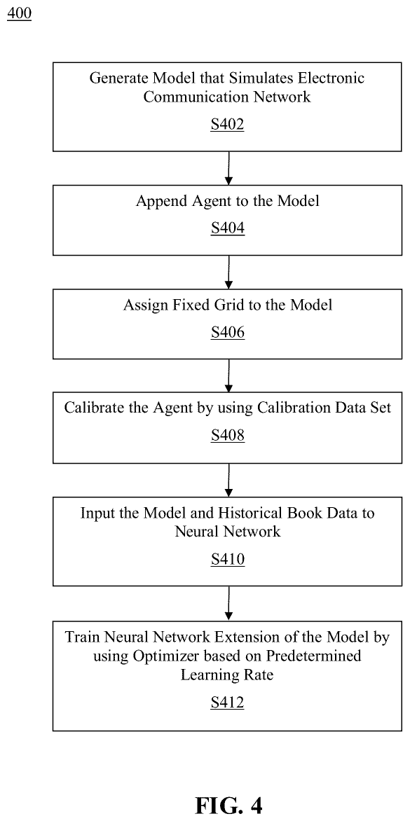

Upon being started, the neural data model management module 302 executes a process for providing a synthetic neural data model that facilitates realistic simulation environments by using a neural network architecture that leverages historical information. An exemplary process for providing a synthetic neural data model that facilitates realistic simulation environments by using a neural network architecture that leverages historical information is generally indicated at flowchart 400 in FIG. 4.

In the process 400 of FIG. 4, at step S402, a model that simulates an electronic communication network may be generated. In an exemplary embodiment, the model may include support for a plurality of orders that relate to at least one from among a market order, a limit order, and a cancel order. The support may enable the plurality of orders on a bid and ask side. In another exemplary embodiment, each of the plurality of orders may be traced by using the model with a first-in-first-out mechanism. Each of the plurality of orders may include a corresponding originator.

In another exemplary embodiment, the electronic communication network may relate to a computerized system that automatically matches buy and sell orders for securities in a financial market. The electronic communication network may be usable to facilitate trading between market participants in different geographic areas who wish to complete a secured transaction without using a third party. The electronic communication networks may connect brokerages and individual traders so they can trade directly between themselves without going through a middleman. The electronic communication networks may correspond to a computer-based system that displays the best available bid and ask quotes from multiple market participants, and then automatically match and execute orders.

In another exemplary embodiment, two desiderata for simulation of the electronic communication network may include: 1) liquidity provider and liquidity target agents may impact the electronic communication network limit order book when sending orders; and 2) in the absence of liquidity provider and liquidity target agent orders, the electronic communication network may evolve realistically over the input simulation timestep. In particular, the volume of the limit order book may remain stable over time and does not explode or vanish. The first desideratum may relate to a structural requirement that follows from the ability of agents to send orders. The second desideratum may be solved by equipping the simulation of the electronic communication network with an electronic communication network agent that is in charge of sending orders at every timestep consistent with present disclosures.

In another exemplary embodiment, the model may include at least one from among a machine learning model, a mathematical model, a process model, and a data model. The model may relate to machine learning algorithms such as, for example, decision tree algorithms, ensemble trees algorithms, neural network architectures algorithms, and linear regression algorithms. Using various machine learning algorithms may result in various corresponding model architectures. For example, a tree-based machine learning model architecture may be computed by using a decision tree algorithm.

In another exemplary embodiment, the model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naïve Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S404, an agent may be appended to the model. The agent may relate to a software component that sends orders to the model based on a predetermined timestep. In an exemplary embodiment, the agent may construct a list of orders at each timestep of the simulation. Although the agent will use the model to build a list of orders, the electronic communication network dynamics are not given by these equations. Rather, the limit order book may evolve solely as a consequence of orders sent by liquidity providers, liquidity targets, and the agent.

In an exemplary embodiment, the mechanism of the agent may be broken down as follows. First, at the beginning of the simulation, the agent may create an initial limit order book snapshot. Then, at each timestep, the agent may: 1) generate a limit order book snapshot variation, precisely two vectors of size Kmax, one for each side, containing volume variations associated to the price grid; and 2) creates a sequence of orders associated to the latter snapshot variation, in the sense that sending those orders to the electronic communication network would reproduce exactly that variation, in the absence of other orders.

At step S406, a fixed grid may be assigned to the model. The fixed grid may include a tick size that relates to a fixed granularity. In an exemplary embodiment, the fixed grid may relate to a fixed price grid that is equipped to the electronic communication network with the fixed granularity, ζ. In the case of Eurodollar on an exchange platform, ζ=0.5 bp. This price grid is upper and lower bounded by Pmax and Pmin, so Kmax: =[ζ\hat{ }{−1}(Pmax-Pmin)] be the total number of ticks. The limit order book snapshot may be usable to reference the associated pair of vectors of size Kmax representing the volumes available for each price, on each side. Pt, Pta, Ptb, the electronic communication network mid-price, best ask and best bid prices may be denoted as, i.e., 2 Pt=Pta+Ptb.

At step S408, the agent may be calibrated by using a calibration data set. In an exemplary embodiment, the calibration data set may relate to level two limit order book data. The calibration data set may include limit order book snapshots for each of a plurality of predetermined times. For example, the calibration data set that is used to calibrate the agent may be level two limit order book data, namely a dataset containing the limit order book snapshot at different times. Such data may not contain volumes for all prices from Pmin to Pmax, typically the data contains volume and price data for the top m non-empty levels on each side, which is typically m=5.

In another exemplary embodiment, the agent together with the model may, therefore, consider the associated volumes (Vî,t)_{i∈[1,2m]}. In order to always have a snapshot for prices from Pmin to Pmax, volumes may be extrapolated for levels k further than m with exponential decay e\hat{ }{-ak}, where a>0 is fitted to the top m levels using the calibration data set. To further reduce the dimensionality of the model, the price difference between two consecutive non-empty levels may be assumed to always be one tick, except for the difference between the best ask and best bid, also called market spread, which can be greater, e.g., typically 1 to 3 ticks. This is typical of liquid markets.

In another exemplary embodiment, with these assumptions, in order to construct the order book at time t+1 from the order book at time t, it is enough to know the mid-price change ζ\hat{ }{−1}(Pt+1−Pt), the new market spread ζ\hat{ }{−1}(Pta+1−Ptb+1), and the change in volume (Vî,t+1−Vî,t)_{i∈[1,2m]} for the top m levels on both sides. The model may, in short, assume that the vectors of these 2m+2 quantities at two distinct times are independent and identically distributed, although accounted for correlation among the 2m+2 random variables at a fixed time.

At step S410, the model and historical book data may be inputted to a neural network. The neural network may enable the parameters of the Gaussian mixture to depend on the historical book data. In an exemplary embodiment, a long-short term memory network (LSTM) and a mixture density network (MDN) may be usable to facilitate the inputting. A LSTM layer first transforms a batch (Sj)_{j∈[t−k+1,t]} ∈R\hat{ }{k·p} of historical window size k=20 into a latent space of dimension L=32. This encoding may be obtained by taking the hidden state of the LSTM.

In another exemplary embodiment, the hidden state may be concatenated with the most recent book snapshot variation St and fed into a fully connected neural network with any combination of input layers, hidden layers, and output layers, one per parameter type of the Gaussian mixture with n components. This may consist of, for each component, its weight π∈R+, mean μ∈Rp, variance σ2 ∈Rp+, and p×p correlation matrix p, a total of n (1+2p+[(p(p−1))/2]) parameters. This may be because the correlation matrix is symmetric and contains ones on the diagonal. Note that suitable output activation functions (exponential, tanh, softmax) may be used to ensure that variances are nonnegative, correlations are in [−1, 1] and mixture weights are nonnegative and sum to one. The network may be trained to maximize the log-likelihood between the training data and that of the Gaussian mixture distribution consistent with present disclosures.

At step S412, a neural network extension of the model may be trained by using an optimizer based on a predetermined learning rate. In an exemplary embodiment, consistent with present disclosures, the total number of Gaussian mixture parameters to learn is dominated by the number of correlation parameters O(np2) because, in this case, p=12. In order to reduce the number of parameters to learn, two cases may be considered.

For the first case, fixed correlation, a correlation matrix between the p random variables St may be precomputed from the training data and used by each mixture component. Consequently, the network solely outputs component weights, means, variances—a total of n·(1+2p) parameters. The training loss may be evaluated using the precomputed correlation matrix. For the second case, shared correlation, the network may learn one correlation matrix that is shared across all mixture components, i.e., each component uses the same learnt correlation matrix. Note that shared correlation may include fixed correlation as a particular case, however distinguishing these two cases is useful to quantify the benefit of learning the correlations vs. computing it in a classical, statistical way using the training data.

In another exemplary embodiment, consistent with present disclosures, the neural network extension may be trained by using an optimizer such as, for example, an ADAM optimizer with learning rate 10-3 up to epoch 110, then 10-4, and a minibatch size of 100. The network weights may be initialized by using an initialization function such as, for example, a XAVIER initialization that is associated with the uniform distribution. Training, validation, and test data sets may be usable when assessing performance of the model and the corresponding neural network extension. The model fit may be performed by using a standard expectation-maximization (EM) algorithm such as, for example, using sklearn implementation. Early stopping may be used as a way to prevent overfitting. That is, training is stopped when the validation loss starts increasing.

In another exemplary embodiment, the neural network extension may be trained by using the optimizer with a first predetermined learning rate. Then, a determination may be made as to whether the optimizer exceeds a predetermined epoch threshold value. The first predetermined learning rate may be reduced to a second predetermined learning rate based on a result of the determining.

In another exemplary embodiment, neural network weights may be initialized by using an initialization function to ensure uniform distribution. The neural network weights may relate to a parameter within the neural network extension that transforms input data within a hidden layer of the neural network extension.

In another exemplary embodiment, performance parameters of the model and the neural network extension may be assessed by using at least one from among a training data set, a validation data set, and a test data set. The validation data set may relate to a portion of the data set that has been set aside to validate the performance of the model.

In another exemplary embodiment, the performance parameters may include a validation loss parameter. Consistent with present disclosures, the validation loss parameter may relate to a metric that is usable to assess the performance of a deep learning model on the validation data set. The validation loss parameter may be calculated from a sum of the errors for each example in the validation data set.

In another exemplary embodiment, the training of the neural network extension may be stopped when the validation loss parameter increases beyond a predetermined validation loss threshold. The validation loss parameter may be measured after each epoch. For example, by measuring the validation loss parameter after each epoch, a determination may be made as to whether the model needs further tuning and/or adjustments. Conversely, the determination may be made that no further tuning and/or adjustments are needed. The determination may be facilitated by plotting a learning curve for the validation loss parameter.

In another exemplary embodiment, changes in volume may be predicted at each of a plurality of levels of a limit order book. The changes in volume may be predicted by using the model. Then, an output may be split into component outputs for transmitting to the electronic communication network. For example, the model may predict a change in volume at each level of the limit order book and split it into smaller orders to be sent to the electronic communication network. Consistent with present disclosures, the output may correspond to orders that are generated to keep the limit order book of the electronic communication network stable. The output may be generated by taking into consideration other orders that are executed by other market participants in the system to make sure that the volume available in the limit order book remains stable.

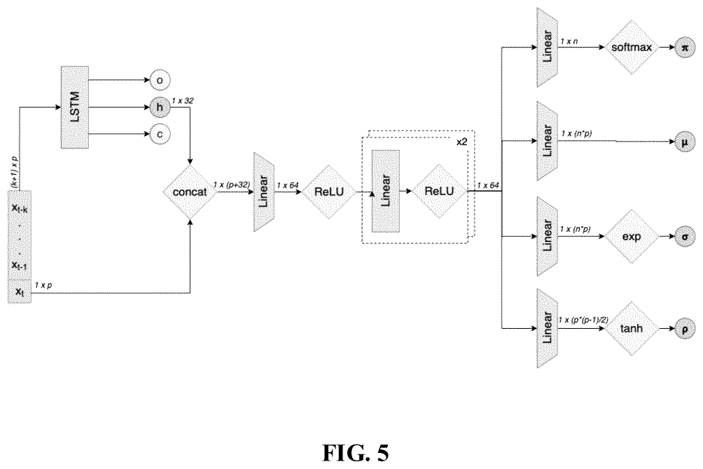

FIG. 5 is a neural network architecture diagram 500 of an exemplary training process for implementing a method for providing a synthetic neural data model that facilitates realistic simulation environments by using a neural network architecture that leverages historical information. In FIG. 5, a synthetic data model may be usable to generate orders to keep a limit order book of the electronic communication network stable by taking into consideration the orders that have been executed by other market partici pants in the system. The synthetic data model may also make sure that the volume available in the limit order book remains stable.

In an exemplary embodiment, the synthetic data model may predict a change in volume at each level of the limit order book and split the orders into smaller orders to be sent to the electronic communication network. A long-short term memory network may be combined with a mixture density network consistent with present disclosures to learn the Gaussian mixtures distribution that characterizes the electronic communication network dynamics.

In another exemplary embodiment, the synthetic data model may guarantee the stability of the limit order book of the electronic communication network. The guaranteed stability may allow the electronic communication network components to be exposed to a wide range of scenarios while remaining consistent. The use of the neural network architecture may also allow the model to learn and exploit the inherent dependency of the limit order book dynamics on its history. The synthetic data model may yield better results than by merely using a simpler Gaussian mixtures model that does not leverage the history. Therefore, the data generated by the model may be more realistic, which produces a more realistic simulation environment.

As illustrated in FIG. 5, an architecture of the neural electronic communication network model is provided. Output parameters of a multivariate Gaussian mixture distribution, i.e., component weights, means, variances, and correlations, with n components may be fitted to the p=2m+2=12 dimensional vector S (t). An order book history h(t): =(Sj) {je [t−k+1, t] of size k=20 is fed as input to the long-short term memory network and the mixture density network and first encoded into a latent space of size 32. The hidden state may be concatenated with the most recent book information St, and feed it to a fully connected neural network with 2 hidden layers of width 64.

Accordingly, with this technology, an optimized process for providing a synthetic neural data model that facilitates realistic simulation of the behavior of the electronic communication network by using a neural network architecture that leverages historical information is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing a synthetic neural data model, the method being implemented by at least one processor, the method comprising:
generating, by the at least one processor, a model that simulates an electronic communication network;
appending, by the at least one processor, at least one agent to the model, the at least one agent relating to a software component that sends at least one order to the model based on a predetermined timestep;
assigning, by the at least one processor, a fixed grid to the model, the fixed grid including a tick size that relates to a fixed granularity;
calibrating, by the at least one processor, each of the at least one agent by using a calibration data set;
inputting, by the at least one processor, the model and historical book data to a neural network; and
training, by the at least one processor via the neural network, a neural network extension of the model by using an optimizer.

2. The method of claim 1, wherein the at least one model includes support for a plurality of orders that relate to at least one from among a market order, a limit order, and a cancel order, the support enabling the plurality of orders on a bid and ask side.

3. The method of claim 2, wherein each of the plurality of orders is tracked by using the at least one model with a first-in-first-out mechanism, each of the plurality of orders including a corresponding originator.

4. The method of claim 1, wherein the calibration data set relates to level two limit order book data, the calibration data set including at least one limit order book snapshot for each of a plurality of predetermined times.

5. The method of claim 1, wherein training the neural network extension further comprises:
training, by the at least one processor, the neural network extension by using the optimizer; and
plotting, by the at least one processor, a learning curve for the neural network extension.

6. The method of claim 5, further comprising:
initializing, by the at least one processor, at least one neural network weight by using an initialization function to ensure uniform distribution,
wherein the at least one neural network weight relates to a parameter within the neural network extension that transforms input data within a hidden layer of the neural network extension.

7. The method of claim 5, further comprising:
assessing, by the at least one processor, at least one performance parameter of the model and the neural network extension by using at least one from among a training data set, a validation data set, and a test data set,
wherein the at least one performance parameter includes a validation loss parameter; and
wherein the training of the neural network extension is stopped when the validation loss parameter increases beyond a predetermined validation loss threshold.

8. The method of claim 1, further comprises:
predicting, by the at least one processor via the model, at least one change in volume at each of a plurality of levels; and
splitting, by the at least one processor, an output into at least one component output for transmitting to the electronic communication network.

9. The method of claim 1, wherein the model includes at least one from among a machine learning model, a mathematical model, a process model, and a data model.

10. A computing device configured to implement an execution of a method for providing a synthetic neural data model, the computing device comprising:
a processor;
a memory; and
a communication interface coupled to each of the processor and the memory,
wherein the processor is configured to:
generate a model that simulates an electronic communication network;
append at least one agent to the model, the at least one agent relating to a software component that sends at least one order to the model based on a predetermined timestep;
assign a fixed grid to the model, the fixed grid including a tick size that relates to a fixed granularity;
calibrate each of the at least one agent by using a calibration data set;
input the model and historical book data to a neural network; and
train, via the neural network, a neural network extension of the model by using an optimizer.

11. The computing device of claim 10, wherein the at least one model includes support for a plurality of orders that relate to at least one from among a market order, a limit order, and a cancel order, the support enabling the plurality of orders on a bid and ask side.

12. The computing device of claim 11, wherein the processor is further configured to track each of the plurality of orders by using the at least one model with a first-in-first-out mechanism, each of the plurality of orders including a corresponding originator.

13. The computing device of claim 10, wherein the calibration data set relates to level two limit order book data, the calibration data set including at least one limit order book snapshot for each of a plurality of predetermined times.

14. The computing device of claim 10, wherein, to train the neural network extension, the processor is further configured to:
train the neural network extension by using the optimizer; and
plot a learning curve for the neural network extension.

15. The computing device of claim 14, wherein the processor is further configured to:
initialize at least one neural network weight by using an initialization function to ensure uniform distribution,
wherein the at least one neural network weight relates to a parameter within the neural network extension that transforms input data within a hidden layer of the neural network extension.

16. The computing device of claim 14, wherein the processor is further configured to:
assess at least one performance parameter of the model and the neural network extension by using at least one from among a training data set, a validation data set, and a test data set,
wherein the at least one performance parameter includes a validation loss parameter; and
wherein the training of the neural network extension is stopped when the validation loss parameter increases beyond a predetermined validation loss threshold.

17. The computing device of claim 10, wherein the processor is further configured to:
predict, via the model, at least one change in volume at each of a plurality of levels; and
split an output into at least one component output for transmitting to the electronic communication network.

18. The computing device of claim 10, wherein the model includes at least one from among a machine learning model, a mathematical model, a process model, and a data model.

19. A non-transitory computer readable storage medium storing instructions for providing a synthetic neural data model, the storage medium comprising executable code which, when executed by a processor, causes the processor to:
generate a model that simulates an electronic communication network;
append at least one agent to the model, the at least one agent relating to a software component that sends at least one order to the model based on a predetermined timestep;
assign a fixed grid to the model, the fixed grid including a tick size that relates to a fixed granularity;
calibrate each of the at least one agent by using a calibration data set;
input the model and historical book data to a neural network; and
train, via the neural network, a neural network extension of the model by using an optimizer.

20. The storage medium of claim 19, wherein the at least one model includes support for a plurality of orders that relate to at least one from among a market order, a limit order, and a cancel order, the support enabling the plurality of orders on a bid and ask side.
